(19) United States
(12) Patent Application Publication
(10) Pub. No.: US 2011/0196898 A1
(43) Pub. Date: Aug. 11, 2011

(54) DATABASE MANAGEMENT PROGRAM AND DATABASE MANAGEMENT APPARATUS

(75) Inventor: Yoshinori Hiyori, Tokyo (JP)

(73) Assignee: FUJITSU BROAD SOLUTION & CONSULTING INC., Tokyo (JP)

(21) Appl. No.: 12/672,366

(22) PCT Filed: Jun. 6, 2008
(86) PCT No.: PCT/JP2008/060459

§ 371 Date: Feb. 5, 2010

(30) Foreign Application Priority Data
Aug. 7, 2007 (JP) 2007-205114

(51) Int. Cl. G06F 17/30

(52) U.S. Cl. 707/803; 707/E17.054

(57) ABSTRACT

A database management program capable of joining three or more tables in a manner that the storage capacity of a memory is more efficiently used. The database management program is configured (programmed) as a program that creates some working tables (WT2-WT4) which hold the information (record identifiers in each table) with which a table in which two tables are joined can be created, and then, by collecting required item values from each table based on the information in the working tables, creates the table whose creation is instructed.

### FIELD

The present invention relates to a database management program and a database management apparatus capable of joining tables.

### BACKGROUND

As known well, general database management programs in recent years are that which can join two or more tables (refer to, e.g., non-patent document 1).

Further, most general database management programs are that which can be instructed to join three or more tables with one command (one SQL statement, etc.), however, such database management program is one that, in order to combine three or more tables, repeats process that creates a table on a memory by joining two tables (for example, a program that, when join three tables A through C in this order, temporarily creates on a memory a table in which the tables A and B are joined, and then joins the table and the table C to create a tables A-C joined table).

And, since information in the table(s) created on the memory in order to join three or more tables does not always match information which must be put into the joined result of the specified tables, the existing database management program is the one that uses the storage capacity of the memory uselessly in creating a table in which three or more tables are joined.
[non-patent documents 1] Nobuhiro Shimura, “MySQL tettei kouryaku guide”, Gijyutsu Hyoron Sya, August, 2002.

### SUMMARY

Such being the case, it is an object of the present invention to provide a database management program and a database management apparatus capable of joining three or more tables in a manner that storage capacity of memory is more efficiently used.

To accomplish the above objects, according to the present invention, a database management program is written (programmed) so as to make a computer performs: a 2nd working table creating step of creating on a memory, from 1st table and 2nd table among 1st through Nth tables to be sequentially joined, a 2nd working table which contains records in each of which a record identifier on the 1st table and a record identifier on the 2nd table are set and is usable to obtain a table into which the 1st table and the 2nd table are joined under a specified condition by joining each record in the table identified by each record identifier set in each record thereof; an Nth working table creating step of executing, after creation of the 2nd working table by the 2nd working table creating step is completed, a (M+1)th working table creating process for each integer value M of from 2 to N−1 sequentially which creates on the memory a (M+1)th working table which contains records in each of which a record identifier of the Mth working table and a record identifier of the (M+1)th table are set, and is usable to obtain a table into which the 1st table through the (M+1)th table are joined under the specified condition by joining each record in a table identified directly or indirectly by each record identifier set in each record thereof from the Mth working table and the (M+1)th table; and a joined table creating step of creating, after creation of the Nth working table by the Nth working table creating step is completed, a table into which the 1st table through the Nth table are joined under the specified condition from information in the 2nd through the Nth working tables created by each working table creating means and information in the 1st table through the Nth table.

Namely, the database management program according to the present invention may be defined as a program that performs joining of three or more tables not by repeating a process that creates a table in which two tables are joined, but by repeating a process that creates a working table the size of which is smaller than that of the table in which two tables are joined. Consequently, it can be said that the database management program according to the present invention is the program that can join three or more tables in a way that uses the storage capacity of the memory more efficiently than the existing database management program does.

It is possible to actualize the database management program according to the present invention as a program that makes the computer performs step(s) different from the above-mentioned various steps in order to join two tables. However, in order to it is desirable to actualize the database management program according to the present invention as the above-mentioned program but as the program wherein the Nth working table creating step is a step that does not function when N=2, and the Nth joined table creating step is a step that, when N=2, creates a table into which the 1st table and the 2nd table are joined on specified condition from information in the 2nd working table and created by the 2nd working table creating step and information in the 1st and the 2nd tables after creation of the 2nd working table by the 2nd working table creating step is completed, since the use of this configuration results in simpler program (facilitating creation/programming of the program).

Further, on the occasion of actualizing the database management program according to the present invention, it is possible to adopt, as each of working table steps, a step of creating a working table directly from two tables. It is also possible to adopt, as the 2nd working table creating step, a step that firstly creates on a memory, from 1st table and 2nd table, a flag table which contains records in each of which the record identifier of the 1st table and the record identifier of the 2nd table and an extraction target identification flag that is information indicating that a record in a table which specified by each record identifier in the self-record is required for which join condition, and then creates the 2nd working table by extracting each record in which extraction record identification flag corresponding to join condition specified for between the 1st table and the 2nd table is set, and to adopt, as the Nth joined table creating step, a step that, for the (M+1) th working table creating process, firstly creates on a memory, from the M working table and the (M+1) working table, a flag table which contains records in each of which the record identifier of the 1st table and the record identifier of the 2nd table and an extraction target identification flag that is information indicating that a record in a table specified directly or indirectly by each record identifier in the self-record is required for which join condition, and then creates the (M+1) th working table by extracting each record in which extraction record identification flag corresponding to join condition specified for between the 1st through the Mth working table and the (M+1) th table is set.

Note that, on the occasion of actualizing the database management program according to the present invention with using a step of creating a working table directly as each of working table steps, in order to facilitate joining of various types, it is desirable to adopt, as each of working table, a step that creates the flag table having the records in each of which a 1st flag indicating that a record in a table specified directly or indirectly by each record identifier in the self-record is required for inner join and right outer join, a 2nd flag indicating that said record is required for inner join, outer join and right outer join, or a 3rd flag indicating that said record is required for outer join and left outer join is set as the extraction target identification flag.

And, since the database management apparatus of the present invention is a apparatus that has same capabilities as that of the computer in which the database management program of the present invention (the database management program according to claim 1), the database management apparatus of the present invention is the one that can join three or more tables in a way that uses the storage capacity of the memory more efficiently than the existing database management program does (in a manner that the memory is not used for memorizing information of a large quantity that does not put into a table in which the 1st table through the Nth table are joined under specified condition).

### DESCRIPTION OF EMBODIMENTS

A best mode for carrying out the present invention will hereinafter be described in depth with reference to the drawings.

As illustrated in FIG. 1, the database management apparatus 10 according to one embodiment of the present invention is an apparatus that is used by connecting several user PCs 30 via a network. Note that, since the database management apparatus 10 is the apparatus configured by installing a database management program (DB management program in the figure) into a relatively high performance computer (in this embodiment, a computer provided with a display and a keyboard), a detailed explanation of the hardware architecture of the database management apparatus 10 is herein omitted.

Each user PC 30 connected to the database management apparatus 10 is an apparatus configured by installing to a computer a client program 30 that is for utilizing the database management apparatus 10 and capable of accepting instructing operation to join two or more tables (operation that specifies tables to be joined, join condition (key item names, join method) of the tables, etc., and instructs execution of table-joining of the specified contents).

The database management program 11 is a program configured to manage, as data that represents the contents of each table that composes a database, not usual table-form data but the FAST structural data so that various data processing (data retrieval processing, sum up processing, etc.) can be done at higher speed (a program that converts the table-form data into the FAST structural data and manages the FAST structural data).

Note that, the FAST structural data may be defined as data that the one corresponding to the table-form data shown in FIG. 2(a) becomes what shown in FIG. 2(b). That is, the FAST structural data is the data which includes the Ordset table that is the list of the record numbers in the table-form data (the list of information interrelating of various item values of each VL table), and includes, for each of items, the VL table that is the sorted list of non-duplicate item values and the VNo table that is the list of the item value number (information that represents the position in VL) of each Ordset value (the FAST structural data is a data corresponding to the data that can be obtained by converting a table-form data to its equivalent data so as to contain no duplicate item values).

This database management program 11 is a program configured (programmed) so as to, when a user of a certain user PC 30 does instructing operation to join three or more tables, create the table of the contents specified by the user without repeating the process of creating a table into which two tables are joined.

To be specific, the database management program 11 is a program that, when joining the 1st though the Nth tables (N≧2) one by one is instructed, executes the sequential join processing the procedure of which is shown in FIG. 3.

That is, in this case, the database management program 11, to begin with, performs process that creates on a memory by referring to the specified join condition (specified key item names of the 1st and the 2nd tables), a flag table from the 1st table and the 2nd table (step S101).

Here, the flag table may be defined as a table having the structure shown in FIG. 4. And, the process of step S101 is the process that, based on join condition between the 1st and the 2nd tables (only key item names specified relating to the 1st and the 2nd tables), specifies from the 1st and 2nd tables each combination of the Ordset values in the records of the 1st and the 2nd tables values of the key item names of which match and each Ordset value in the record the value of which is not set in any records in the other table, and creates the flag table containing: (a) for each combination of the Ordset values in the records of the 1st and the 2nd tables values of the key item names of which match, record in which each of these values is set as the record identifier of each table (the record identifier shown at the left hand of the figure is that of the 1st table) and “2” is set as the flag; (b) for each Ordset value in the record of the 2nd table the value of which is not set in any records in the 1st table, record in which null, the Order set value, “1” are set as the record identifier relating to the 1st table, the record identifier relating to the 2nd table, flag, respectively; (c) for each Ordset value in the record of the 1st table the value of which is not set in any records in the 2nd table, record in which the Order set value, null, “3” are set as the record identifier relating to the 1st table, the record identifier relating to the 2nd table, flag, respectively. The database management program 11 having finished the process of step S101 (see FIG. 3) performs process that creates, by extracting each record (accurately, the record identifier(s) of each record) flag value of which corresponds to the join method (INNER JOIN, OUTER JOIN, etc.) from the created flag table, a 2nd working table having the structure shown in FIG. 5 (step S102).

The process of the step 102 is defined as the process that creates, if join method specified for the 1st and the 2nd tables (denoted hereinafter as specified join method) is INNER JOIN, the 2nd working table by extracting each record the flag value of which is equal to “2” and creates, if the specified join method is LEFT OUTER JOIN, the 2nd working table by extracting each record flag value of which is equal to “2” or “3”. Further, the process of the step 102 is the one that creates the 2nd working table by extracting each record flag value of which is equal to “1” or “2” if the specified join method is RIGHT OUTER JOIN, and creates the 2nd working table by extracting all records if the specified join method is OUTER JOIN.

Note that, the M+1 working table (M>2) created in step S106 described later is also the one having the structure shown in FIG. 5, and the database management program 11 is the program that separately manages relationship between each record identifier in each working table and the tables on the memory.

The database management program 11 having finished the process of step S102, if the number of tables to be joined is “2” (steps S103, S104; NO), performs process that creates a table into which the 1st table and 2nd table are joined under specified condition based on the information in the 2nd working table on the memory and the 1st and the 2nd tables (step S108). In other words, at this step 108, the database management program 11 performs process that, by collecting required item values from the 1st and the 2nd tables based on the information in the 2nd working table, creates (prepares) on the memory the table in which the 1st table and 2nd table are joined. Then, the database management program 11 normally (if the instructing operation by the user is not the special one) terminates the processing of this figure after performing process (not shown in the figure) that transmits the information relating to the created table to the user PC 30 used by the user who instructed to combine tables.

On the other hands, if the number of tables to be joined is more than “3”, the database management program 11 performs for each integer value M of from 2 to N−1 (steps S103, S104, S107) process that creates, by referring specified join condition, a flag table on the memory in the same way as done in step S102 (process of creating the flag table using record number of the Mth working table instead of the Ordset value relating to the 1st table: step S105) and process that creates the Mth working table by extracting, in the same way as done in step S103, each record the flag value in which corresponds to the join condition from the created flag table (step S106).

And, if creation of the Nth working table (the (M+1)th working table in case where N=M−1) is completed, the database management program 11 performs the process of creating, based on the information in the 2nd through the Nth tables on the memory created through the foregoing process and the information in the 1st through the Nth tables, a table in which the 1st though the Nth table are joined under the specified condition on the memory (step S108). Namely, in this case, the database management program 11 performs process that collects required item values from the 1st and the 2nd tables based on the information in the 2nd working table, creates (prepares) on the memory the table into which the 1st table and 2nd table are joined. Then, the database management program 11 terminates the processing of this figure after performing process (not shown in the figure) that transmits the information relating to the created table to the user PC 30.

To sum up, the sequential join processing executed by the database management program 11 of the present embodiment is the process that, as schematically shown in FIG. 6, for example, if tables T1-T4 are to be joined, creates three working tables WT2-WT4, and then, by collecting required item values from the tables T1-T4 based on the information in the working tables, creates the table in which the tables T1-T4 are joined.

And, as schematically shown in FIG. 7, the database management program 11 is also the program that achieves more complex joining of tables by creating some working tables on the memory.

As is clear from the description given above, each of the database management apparatus 10 and the database management program 11 according to one embodiment of the present invention is the one that achieves joining of three or more tables not by repeating the process that creates the table in which two tables are joined, but by repeating the process that creates the working table(s) the size of which is(are) smaller than that of the table in which two tables are joined. Consequently, it can be said that each of the database management apparatus 10 and the database management program 11 of the present embodiment is the one that can join three or more tables in a way that uses the storage capacity of the memory more efficiently than the existing database management program does (in a manner that the memory is not used for memorizing information of a large quantity that does not put into a table in which the 1st table through the Nth table are joined under specified condition).

### Modified Example

Each of the database management apparatus 10 and the database management program 11 discussed above can be modified in a variety of forms. For instance, the database management apparatus 10 can be modified to the apparatus in which the above-mentioned processing is executed by ASIC. Further, the database management program 11 can be modified to the one that installing of special software to each user PC 30 is unnecessary (program that makes user of each user PC 30 use information in the database by offering script or HTML/XML data to each user PC 30).

Still further, the database management program 11 can be modified to the program which creates working tables without creating flag tables, the program which cannot execute the above-mentioned four kinds of joining (which can execute inner join only, etc.), the program which manages data for various tables as table-form data, and so on.

### BRIEF DESCRIPTION OF THE DRAWINGS

FIG. 1 is a configuration diagram of the database management apparatus according to one embodiment of the present invention;

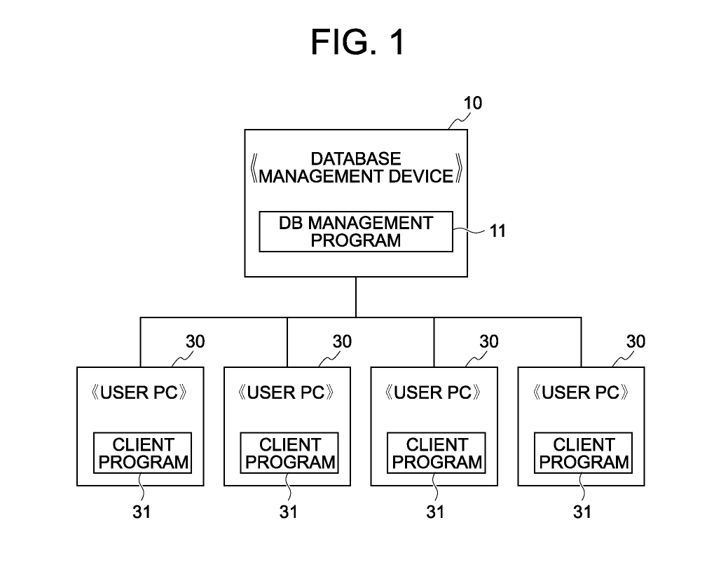

FIG. 2 is an explanatory diagram of the FAST structural data;

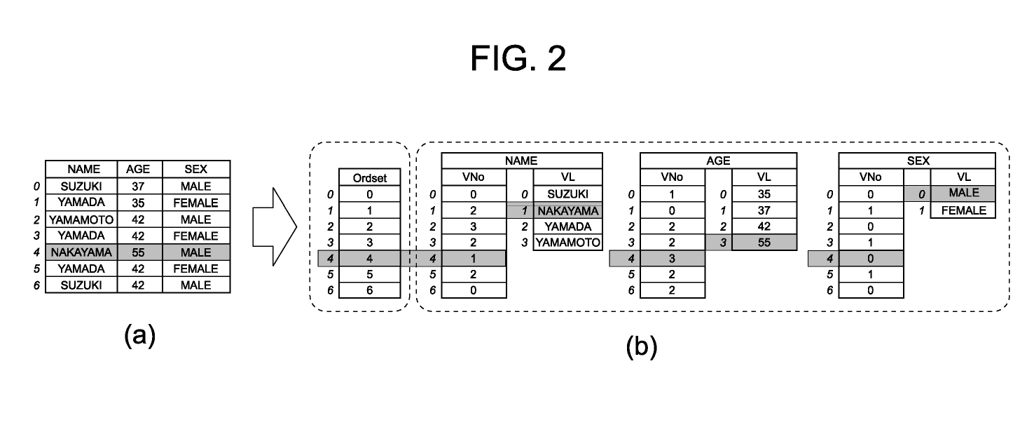

FIG. 3 is a flowchart of the sequential join processing processes that the database management apparatus executes;

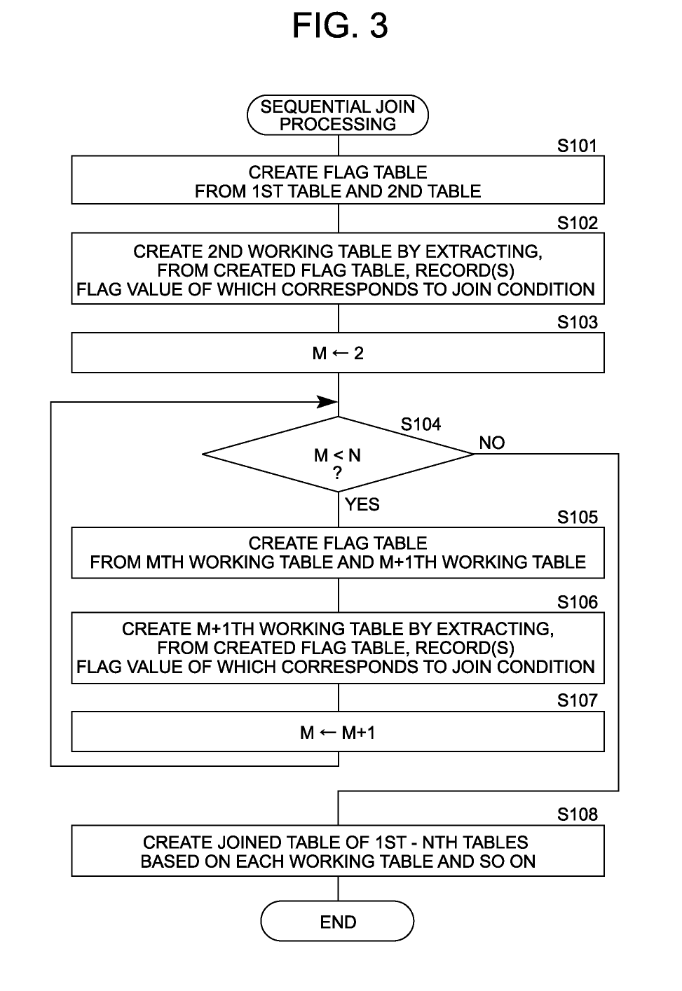

FIG. 4 is an explanatory diagram of the flag table that the database management apparatus creates on the memory;

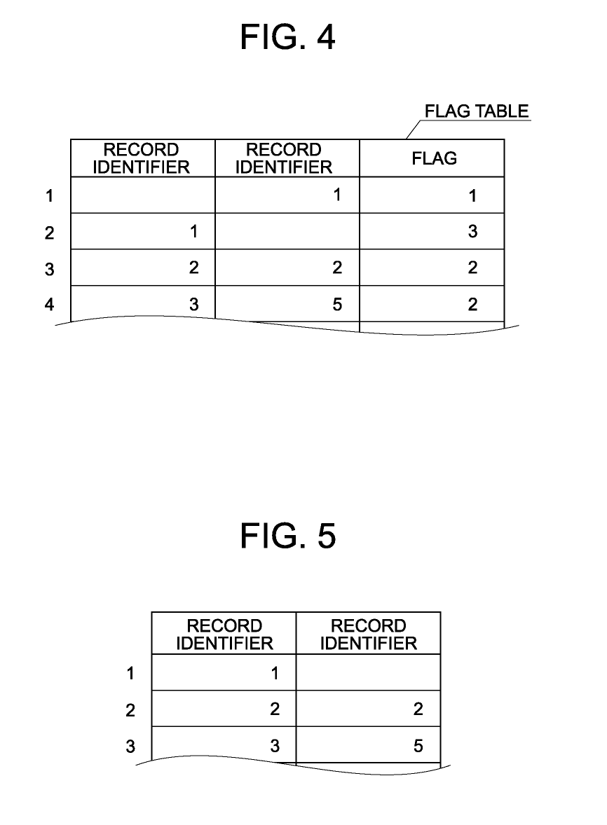

FIG. 5 is an explanatory diagram of the sequential join processing;

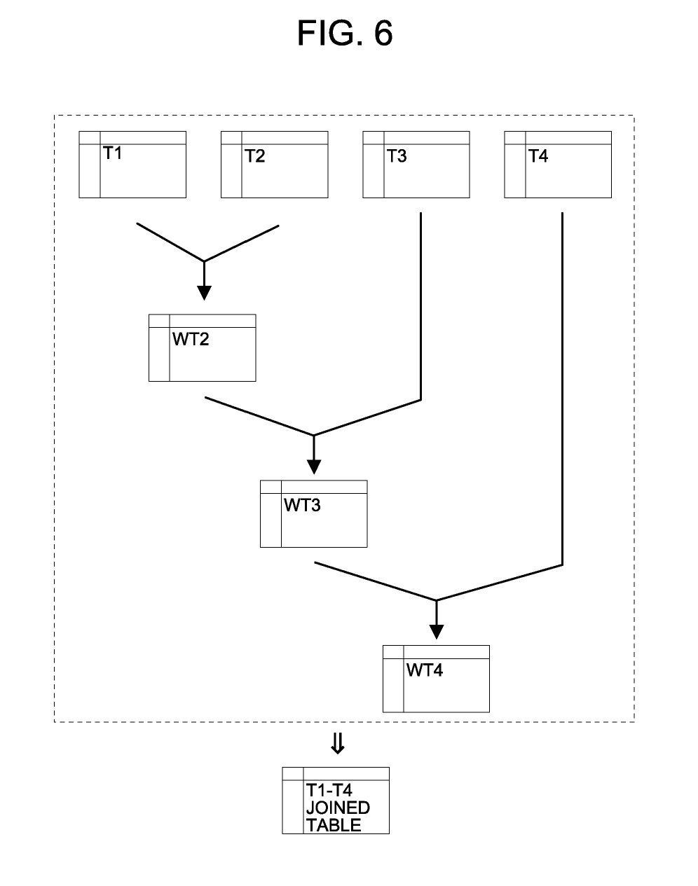

FIG. 6 is an explanatory diagram of other table-joining process that the database management apparatus executes.

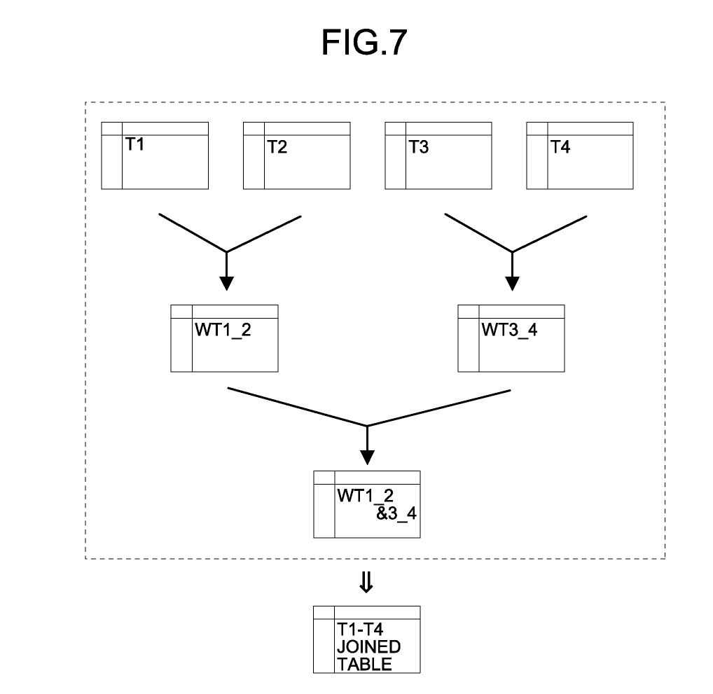

1. A computer-implemented method capable of joining more than three tables, said method comprising:
a 2nd working table creating step of creating on a memory, from 1st table and 2nd table among 1st through Nth tables to be sequentially joined, a 2nd working table which contains records in each of which a record identifier on the 1st table and a record identifier on the 2nd table are set and is usable to obtain a table into which the 1st table and the 2nd table are joined under a specified condition by joining each record in the table identified by each record identifier set in each record thereof;
an Nth working table creating step of executing, after creation of the 2nd working table by the 2nd working table creating step is completed, a (M+1)th working table creating process for each integer value M of from 2 to N−1 sequentially which creates on the memory a (M+1)th working table which contains records in each of which a record identifier of the (M+1)th working table and a record identifier of the (M+1)th table are set, and is usable to obtain a table into which the 1st table through the (M+1)th table are joined under the specified condition by joining each record in a table identified directly or indirectly by each record identifier set in each record thereof from the Mth working table and the (M+1)th table; and
a joined table creating step of creating, after creation of the Nth working table by the Nth working table creating step is completed, a table into which the 1st table through the Nth table are joined under the specified condition from information in the 2nd through the Nth working tables created by each working table creating step and information in the 1st table through the Nth table.

2. A computer-implemented method according to claim 1, wherein the Nth working table creating step is a step that does not function when N=2, and
the joined table creating step is a step that, when N=2, creates a table into which the 1st table and the 2nd table are joined under the specified condition from information in the 2nd working table created by the 2nd working table creating step and information in the 1st and the 2nd tables after creation of the 2nd working table by the 2nd working table creating step is completed.

3. A computer-implemented method according to claim 1 or 2, wherein the 2nd working table creating step is a step that firstly creates on a memory, from 1st table and 2nd table, a flag table which contains records in each of which the record identifier on the 1st table and the record identifier on the 2nd table and an extraction target identification flag that is information indicating that a record in a table which specified by each record identifier in the self-record is required for which join condition, and then creates the 2nd working table by extracting each record in which extraction identification flag corresponding to join condition specified for between the 1st table and the 2nd table is set, and
the Nth joined table creating step is a step that, for the (M+1)th working table creating process, firstly creates, from the M working table and the (M+1) working table, a flag table on a memory which contains records in each of which the record identifier on the 1st table and the record identifier on the 2nd table and an extraction target identification flag that is information indicating that a record in a table specified directly or indirectly by each record identifier in the self-record is required for which join condition, and then creates the (M+1)th working table by extracting each record in which extraction identification flag corresponding to join condition specified for between the 1st through the Mth working table and the (M+1)th table is set.

4. A computer-implemented method according to claim 1, wherein each of the 2nd working table creating step and the Nth joined table creating step is a step that creates the flag table having the records in each of which a 1st flag indicating that a record in a table specified directly or indirectly by each record identifier in the self-record is required for inner join and right outer join, a 2nd flag indicating that said record is required for inner join, outer join, left outer join and right outer join, or a 3rd flag indicating that said record is required for outer join and left outer join is set as the extraction target identification flag.

5. A database management device capable of joining more than three tables, said device comprising:
a 2nd working table creating means for creating on a memory, from 1st table and 2nd table among 1st through Nth tables to be sequentially joined, a 2nd working table which contains records in each of which a record identifier on the 1st table and a record identifier on the 2nd table are set and is usable to obtain a table into which the 1st table and the 2nd table are joined under a specified condition by joining each record in a table identified by each record identifier set in each record thereof;
an Nth working table creating means for executing, after creation of the 2nd working table by the 2nd working table creating means is completed, a (M+1)th working table creating process for each integer value M of from 2 to N−1 sequentially which creates on the memory a (M+1)th working table which contains records in each of which a record identifier on the (M+1)th working table and a record identifier on the (M+1)th table are set, and is usable to obtain a table into which the 1st table through the (M+1)th table are joined under the specified condition by joining each record in a table identified directly or indirectly by each record identifier set in each record thereof from the Mth working table and the (M+1)th table; and
a joined table creating means for creating, after creation of the Nth working table by the Nth working table creating means is completed, a table into which the 1st table through the Nth table are joined under the specified condition from information in the 2nd through the Nth working tables created by each working table creating means and information in the 1st table through the Nth table.
